(19) United States
(12) Patent Application Publication
(10) Pub. No.: US 2011/0105098 A1
(43) Pub. Date: May 5, 2011

(54) SYSTEM AND METHOD FOR SYNCHRONIZING LANGUAGES

(75) Inventors: STEVEN C. TENGLER, GROSSE POINTE PARK, MI (US); WILLIAM E. MAZZARA, JR., DRAYTON PLAINS, MI (US)

(73) Assignee: GENERAL MOTORS LLC, DETROIT, MI (US)

(21) Appl. No.: 12/610,861

(22) Filed: Nov. 2, 2009

(51) Int. Cl. H04M 3/00

(52) U.S. Cl. 455/418

(57) ABSTRACT

A system for synchronizing changes of a telematics language from a current telematics language to a proposed telematics language with changes made to a vehicle language from a current vehicle language to a new vehicle language through involvement of a call center is described. The system includes, but is not limited to an antenna adapted for attachment to a vehicle and configured for communicating with the call center. The system further includes a telematics unit adapted for attachment to the vehicle and communicatively connected to the antenna. The telematics unit is configured to monitor a vehicle bus to detect when a user changes the vehicle language to the new vehicle language and further configured to automatically initiate contact with the call center when the change in the vehicle language is detected to confirm a user desire to change the telematics language to the new vehicle language.

### TECHNICAL FIELD

The technical field generally relates to telematics units and more particularly to telematics units that are configured to interact with a user in multiple languages.

### BACKGROUND

Many vehicles in the marketplace are equipped with telematics units that are designed, constructed, and programmed to enable a user of the vehicle (hereinafter “user”) to interact with a communications network. The communication network includes a remotely located call center (hereinafter “call center”) staffed with live advisors (hereinafter “advisors”) who are trained to provide assistance to the user. Through the communication network, a user may utilize a wide variety of telematics services that are designed to facilitate and/or enhance the user's driving and/or vehicle ownership experience. Such services include, but are not limited to, navigation assistance, vehicle monitoring, and telecommunication services. These telematics services may be provided by a manufacturer of the vehicle, by a manufacturer of the telematics units, or by some other telematics service provider.

In some models of telematics units, the primary method by which a user interacts with the telematics unit is through speech, i.e., by uttering voice commands. Such telematics units include Human Machine Interface (HMI) engines that utilize voice recognition technology/software to enable the telematics unit to respond to human voice commands. Such models utilize computer memory to store voice commands. In some examples, the telematics unit may store hundreds of voice commands that may be associated with in-vehicle textual displays.

With respect to the telecommunication services provided by the telematics units, many telematics units are configured to enable a user to make hands-free telephone calls. A user need only utter the appropriate command(s) and the telematics unit will dial a phone number and connect the user to a party at a distant end. To facilitate use of this hands-free calling feature, the telematics unit may provide the user with an ability to store contact information in an electronic address book. The electronic address book may be set up to provide the user with the ability to associate a name tag with each contact listed in the electronic address book. A user may need only to utter the command that initiates a phone call and then utter the name tag associated with the contact that the user desires to call, and the telematics unit may then place the call and connect the parties. Thus, name tags can make the initiation of a phone call far more convenient for the user by alleviating the need for the user to memorize the phone number for each contact and the need to speak each digit of the contact's phone number. This reduces the task load on the user and accelerates the user's ability to initiate a phone call.

To store a name tag in the telematics unit, the telematics unit enters a recording mode and the user utters a name tag of the user's choosing for association with a particular contact. The telematics unit then compares the name tag with each of the stored voice commands to see if the proposed name tag is similar to any of the voice commands. If the name tag is similar to an existing voice command, then the name tag is rejected and will not be stored. This prevents confusion on the part of the telematics unit when the user is interacting with it.

Because vehicles are sold in several different countries and because the user may speak a language other than English, the telematics units are designed and programmed to interact with users in multiple different languages. All of the voice commands are programmed/recorded into the telematics units in each of the available languages so that all of telematics services may be available in each of the languages that are supported by the telematics unit. The user may select a preferred language for interacting with the telematics unit (the “telematics language”) at the time of vehicle purchase or at the time that the user subscribes to the telematics services or at any other time during the life of the vehicle. Additionally, the user may change back and forth between available telematics languages as often as the user desires.

One consequence of changing the telematics language is that all of a user's name tags will be deleted each time that the user changes the telematics language. This is because the stored nametags have not been compared with the stored voice commands in the newly selected language and to avoid confusion, the stored nametags are deleted. The loss of all stored nametags can be inconvenient for the user. For example, the user will need remember the phone number for each of the user's contacts instead of merely needing to remember the name tag of that contact. Additionally, the user will need to recite that contact's entire phone number when placing a call to that contact through the telematics unit instead of simply uttering the name tag for that contact.

In a known system, a user may effect a change of the telematics language in one of two ways. First, the user may actuate mechanisms in the vehicle that are connected to the telematics unit and which direct the telematics unit to change the telematics language. This will result in an audible voice prompt warning the user that the requested action will result in the loss of the user's name tags. Alternatively, the user may contact the call center and ask an advisor to effect the change to the telematics language. The advisor can then inform the user of the consequence associated with changing from the existing telematics language (hereinafter, the “current telematics language”) to a different telematics language (hereinafter, the “proposed telematics language”). If the user confirms their desire to change telematics languages, the advisor will consummate the change by sending an appropriate signal to the user's telematics unit. During this call to the call center, the advisor may also update the user's profile to reflect the users' selection of the proposed telematics language which, in turn, may impact how future calls by the user to the call center are routed. For example, if the user switches the telematics language from English to Spanish, the user's next call to the call center may be routed automatically to a Spanish speaking advisor.

In addition to the telematics unit, several other systems in the vehicle are also configured to communicate with the user. For example, the vehicle may include an electronic component such as a vehicle information center or a radio that provides information to the user about the vehicle (i.e., vehicle maintenance concerns, fuel levels, internal and external temperatures, etc. . . . ) through a text-based interface. In some instances, such an interface with the user may also be verbal.

As with the telematics unit, such electronic components may also configured to communicate with the user in multiple different languages (hereinafter, the “vehicle language”). The user may select any of the multiple vehicle languages available and may, at any time, change from an existing vehicle language (hereinafter, the “current vehicle language”) to a different vehicle language (hereinafter, the “new vehicle language”). Unlike the telematics unit, this change occurs at the vehicle without the involvement or intervention of any outside entity.

This ability to change from the current vehicle language to the new vehicle language through the electronic component may create an understanding or an expectation by the user that the telematics language has also changed to the new vehicle language. The user may assume that the electronic component is a master component and that all other electronic components in the vehicle, including the telematics unit, are slave components that can be controlled through the master component. Accordingly, the user may deliberately attempt to change the telematics language through the electronic component. However, many telematics units are currently not synchronized to the electronic component and therefore a change of vehicle language will not result in a change of the telematics language.

### SUMMARY

A system and a method for synchronizing languages are disclosed herein. In a first non-limiting example, a system for synchronizing changes of a telematics language from a current telematics language to a proposed telematics language with changes made to a vehicle language from a current vehicle language to a new vehicle language through involvement of a call center is described. The system includes, but is not limited to an antenna that is adapted for attachment to a vehicle and that is configured for transmitting and receiving communication transmissions to and from the call center. The system further includes a telematics unit that is adapted for attachment to the vehicle and that is communicatively connected to the antenna. The telematics unit is configured to monitor a vehicle bus to detect when a user changes the vehicle language from the current vehicle language to the new vehicle language. The telematics unit is further configured to automatically initiate contact with the call center when the change in the vehicle language is detected to confirm a user desire to change the telematics language to the new vehicle language.

In a second non-limiting example, the system includes, but is not limited to an electronic component that is configured to be mounted to a vehicle and that is configured to enable a user to change the vehicle language to the new vehicle language. The system further includes a telematics unit that is adapted for attachment to the vehicle and that is communicatively connected to the electronic component. The telematics unit is configured to detect a change in the vehicle language, and to automatically initiate contact with the call center when the change in the vehicle language is detected to confirm a user desire to change the telematics language to the new vehicle language.

In a third non-limiting example, a method for synchronizing languages is disclosed. The method includes, but is not limited to, receiving, at a telematics unit, information that is indicative of a user initiated change of a vehicle language from a current vehicle language to a new vehicle language. The method further includes automatically initiating contact with a call center using the telematics unit. The method also includes confirming, by the call center, that the user desires to change the telematics language from a current telematics language to the new vehicle language.

### DESCRIPTION OF THE DRAWINGS

One or more examples will hereinafter be described in conjunction with the following drawing figures, wherein like numerals denote like elements, and

FIG. 1 is a schematic view of a communication system compatible for use with the systems and methods for synchronizing languages disclosed herein;

FIG. 2 is a schematic view of a vehicle equipped with non-limiting example of a system for synchronizing languages in accordance with the teachings disclosed herein;

FIG. 3 is a schematic view of the system for synchronizing languages of FIG. 2 engaging with the communication system of FIG. 1; and

FIG. 4. is a flow chart illustrating a non-limiting example of a method for synchronizing languages in accordance with the teachings disclosed herein.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

One solution to the problem described above is to configure the telematics unit to monitor the electronic component directly or to monitor a vehicle bus or other line of communication over which the electronic component transmits messages. This enables the telematics unit to detect changes in the vehicle language. The telematics unit is further configured to interpret a change from the current vehicle language to the new vehicle language as being a user initiated request to change the current telematics language to the new vehicle language. Accordingly, the telematics unit will automatically initiate contact with the call center to alert an advisor of the user's request to change the current telematics language to a proposed telematics language (i.e., the new vehicle language). The advisor can then inform the user of the consequences of such a change in the telematics language.

Once the advisor has confirmed that the user wishes to change languages, the advisor can complete the transaction by transmitting a signal to the telematics unit that changes the current telematics language to the proposed telematics language. The advisor can also update the user's profile to indicate the user's election of the proposed telematics language. This may facilitate future contact and/or communication between the user and the call center by enabling the call center to route any future contact from the user to an advisor who speaks the proposed telematics language.

If, after being advised of the consequences of changing the telematics language, the user declines to do so, the telematics unit will continue to interact with the user in the current telematics language despite the change from the current vehicle language to the new vehicle language. Such involvement by the call center comports with the user's expectation that a change of the vehicle language through the electronic component will also result in a change in the telematics language, and thus avoids the disappointment and confusion discussed above. Additionally, such intervention by the call center can apprise the user of the consequences of a change of the telematics language and thus avoids the inconvenience caused by an undesired loss of the user's name tags.

A greater understanding of the examples of the systems and methods disclosed herein may be obtained through a review of the illustrations accompanying this application together with a review of the detailed description that follows.

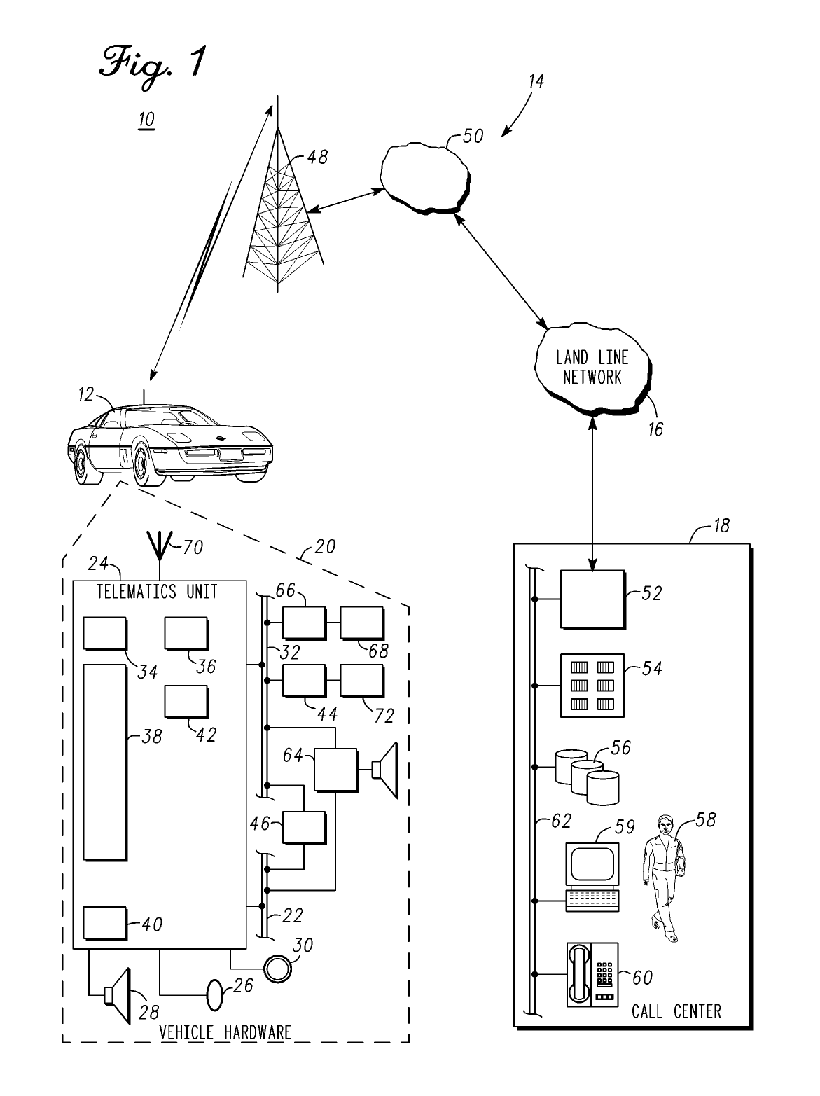

With reference to FIG. 1, there is shown a non-limiting example of a communication system 10 that may be used together with examples of the systems disclosed herein and also to implement examples of the methods disclosed herein. The communication system generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over system communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GPS chipset/component 42. In one example, the wireless modem 36 includes a computer program and/or set of software routines adapted to be executed within processing device 38.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. In order to enable successful data transmission over the voice channel, wireless modem 36 applies some type of encoding or modulation to convert the digital data so that it can be communicated through a vocoder or speech codec incorporated in the cellular chipset/component 34. Any suitable encoding or modulation technique that provides an acceptable data rate and bit error can be used with the present examples. Dual mode antenna 70 services the GPS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons or controls 30 for enabling a vehicle occupant to activate or engage one or more of the vehicle hardware components 20. For example, one of the buttons and/or controls 30 can be an electronic pushbutton used to initiate voice communication with call center 18 (whether it be a human such as advisor 58 or an automated call response system 59 (hereinafter “ACR 59”) utilized in lieu of a human advisor). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless system 14 with land network 16. As appreciated by those skilled in the art, various cell tower/base station/MSC arrangements are possible and could be used with wireless carrier system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either the live advisor 58 or an automated response system, and data transmissions are passed on to a modem or other piece of telecommunication/computer equipment 60 for demodulation and further signal processing. The telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a manned call center 18, it will be appreciated that the call center 18 can be any central or remote facility, manned or unmanned, mobile or fixed, to or from which it is desirable to exchange voice and data.

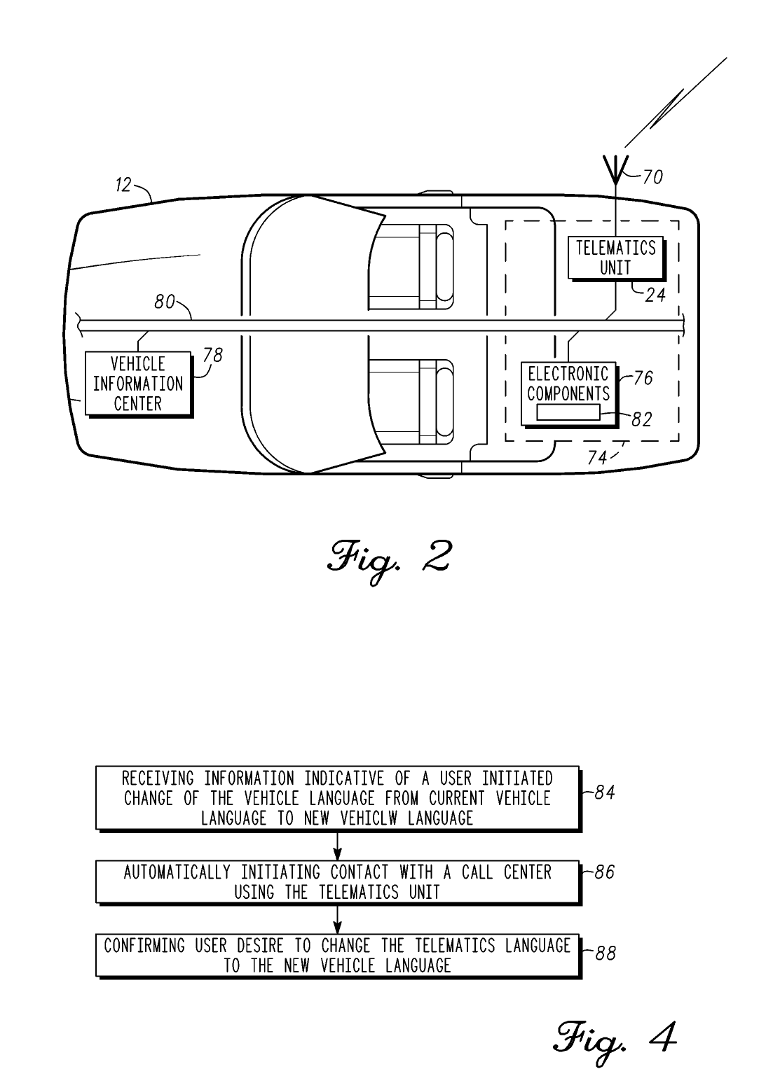

With respect to FIG. 2, a schematic view of vehicle 12 equipped with a non-limiting example of a synchronizing system 74 is illustrated. Synchronizing system 74 includes telematics unit 24 and an electronic component 76. Synchronizing system 74 facilitates the synchronization of the telematics language with the vehicle language.

Vehicle 12 may include several electronic components that communicate with a user of vehicle 12. One exemplary electronic component may be a vehicle information center 78. Vehicle information center 78 may include a read out panel or other visual display on which messages can be displayed for the purpose of communicating information to the user regarding the condition of the vehicle and its environment. The messages may be conveyed through a combination of images and text. In some examples, audible alerts and verbal messages may be provided together with the images and text. Some examples of the types of messages provided by vehicle information center 78 include, but are not limited to, the distance traveled during a trip, the vehicle's interior temperature, the temperature external to the vehicle, the distance that can be traveled before depleting fuel reserves, the air pressure in the vehicle's tires, the remaining life span of the vehicle's motor oil life, the open state of the vehicle's doors and trunk, and the engine's temperature.

Vehicle information center 78 may be capable of displaying these messages in several different vehicle languages. For example, vehicle information center 78 may be programmed to communicate with a user in English, Spanish, French, German, Italian, Mandarin Chinese, Japanese, Korean, Vietnamese, Portuguese, Hebrew, Russian, Arabic, or any of number of other languages spoken by persons around the world. The user may select a language from among those languages supported by vehicle information center 78 and the messages will be displayed in that chosen language.

Vehicle information center 78 is connected to vehicle bus 80. Vehicle bus 80 is a subsystem that is configured to transfer data between computer components in a manner that is well known in the art. Vehicle bus 80 permits the sharing of data between all computer components connected to vehicle bus 80 and also enables remote control of the individual computer components by other computer components connected to vehicle bus 80. For example, the vehicle language used by vehicle information center 78 can be selected by providing instructions to vehicle information center 78 across vehicle bus 80.

Several other electronic components may also be communicatively connected to one another across vehicle bus 80. Each of these other electronic components may be configured to communicate messages to a user of vehicle 12 in one of several available languages. For example, a radio, a video cassette recorder, a DVD player, a navigation system, a backup assist video camera, a collision warning system, and several other components may each be configured to communicate messages to the user relating to their specific function.

A representative electronic component, electronic component 76, is illustrated in FIG. 2. Electronic component 76 is configured to communicate messages to a user of vehicle 12 and is further configured to communicate with the user in several available languages. Electronic component 76 may also include a display mechanism (not shown) for displaying messages to the user of vehicle 12.

Electronic component 76 includes an electronic processing device 82 that is configured to control electronic component 76. In the illustrated example, electronic processing device 82 is housed within electronic component 76. It should be understood that in other examples, electronic processing device 82 may be a separate component that controls electronic component 76 remotely, and which may also control additional electronic components. Electronic processing device 82 may be a computer, a processor, a micro-processor, a controller, or any other type of computer component effective for controlling electronic component 76. Electronic component 76 may include an interface (not shown) that allows a user to give instructions or commands to electronic processing device 82, which, in turn, controls electronic component 76. Examples of interfaces that may be used for this purpose include, but are not limited to, a key pad, a joy stick, a touch screen, a button(s), a dial(s), or any other mechanism or combination of mechanisms that are effective for interfacing with electronic processing device 82.

Electronic component 76 is connected to vehicle bus 80. Accordingly electronic component 76 is communicatively connected to vehicle information center 78 and to every other electronic component connected to vehicle bus 80.

Electronic component 76 is further configured and programmed to enable the user to select the vehicle language for some or for all of the other electronic components connected to vehicle bus 80. For example, if the user switches from the current vehicle language (e.g., English) to a new vehicle language (e.g., Spanish) using electronic component 76, then electronic component 76 sends instructions across vehicle bus 80 to each of the other electronic components that are communicatively connected to vehicle bus 80 to switch from English to Spanish. In this manner, vehicle information center 78 will now display all messages to the user in Spanish. This arrangement conveniently allows the user to avoid having to change the vehicle language for each component one at a time by permitting the user to change the vehicle language for all electronic components on vehicle 12 through an interaction with only one component.

As discussed above, telematics unit 24 is configured to support a wide variety of services that facilitate and/or enhance the user's driving experience. One such service that is supported by telematics unit 24 is a telecommunication service. Telematics unit 24, in conjunction with other components discussed above with respect to FIG. 1, enable the user to make hands free telephone calls from vehicle 12 by depressing buttons and/or controls 30 and by uttering predetermined voice commands.

Telematics unit 24 is also configured to maintain an electronic address book for the storage of contact information for parties that the user intends to contact more than once. Telematics unit 24 is further configured to associate a name tag with each stored contact. This permits the user to utter the name tag associated with the party that the user desires to call instead of having to remember and recite the entire phone number.

Telematics unit 24 is further configured to communicate with the user audibly, and in some examples, through the use of a visual display. Telematics unit 24 is programmed to engage in such communications in one of multiple languages. The user may select a language for communication from among the multiple available languages and all subsequent communications between the user and telematics unit 24 and also between the user and call center 18, will be in the selected language until the user selects a new language.

Telematics unit 24 is also configured to automatically initiate contact with call center 18 in the event that the user attempts to change the telematics language from the current telematics language to a proposed telematics language. This contact is initiated for the purpose of apprising the user of the consequences of changing the telematics language (i.e., that all name tags will be deleted).

As illustrated, telematics unit 24 is communicatively connected to, and is configured to monitor, vehicle bus 80. Through this connection to vehicle bus 80, telematics unit 24 can monitor communications across vehicle bus 80 and can detect instructions and/or commands issued by electronic component 76 to change the vehicle language from the current vehicle language to a new vehicle language. In other examples, telematics unit 24 may be directly communicatively connected to electronic component 76 to directly monitor that component for changes in the vehicle language.

Telematics unit 24 is further configured to interpret changes and/or instructions/commands to change from a current vehicle language to a new vehicle language as being a request by the user to change from the current telematics language to a proposed telematics language (i.e., the new vehicle language). This causes telematics unit 24 to automatically initiate contact with call center 18 to confirm the user's desire to change the telematics language.

In other examples, a change of the telematics language may trigger a corresponding change in the vehicle language. For example, once a user's request to change the telematics language has been consummated by advisor 58, telematics unit 24 may broadcast the new telematics language on vehicle bus 80. Electronic component 76 may be configured to monitor vehicle bus 80 for changes to the telematics language and may be further configured to change the vehicle language to a new vehicle language that corresponds with the new telematics language. In other examples, rather than having electronic component 76 monitor for changes of the telematics language, telematics unit 24 may be configured to transmit instructions along vehicle bus 80 (or otherwise) to electronic component 76 commanding a change of the vehicle language to a new vehicle language that corresponds with the new telematics language.

With respect to FIG. 3, an example of synchronizing system 74 as it engages with communication system 10 is schematically illustrated. As indicated in FIG. 3, the current telematics language and the current vehicle language is English. The user has just changed the vehicle language to Spanish. Electronic component 76 has just broadcasted this change of vehicle language to Spanish over vehicle bus 80 and telematics unit 24 has just detected this broadcasted change. Upon detection of this change in vehicle language, telematics unit 24 automatically initiates a call to call center 18 to put the user in contact an advisor who can confirm that the user wishes to also change the telematics language to Spanish.

When telematics unit 24 initiates a call to call center 18, the initial portion of the call consists of data communication between telematics unit 24 and computer systems at call center 18. The language selection is uploaded to the call center in a data portion of the call placed to the call center 18. During this initial portion of the call, telematics unit 24 electronically provides identifying information such as a vehicle identification number (VIN) and a station identification number which identify vehicle 12 and telematics unit 24, respectively. Also included in the data portion of the call is current latitude and longitude location of the vehicle 12. The receipt of this information permits call center 18 to access a user profile associated with vehicle 12. Included in the user's profile is an identification of the language spoken by the user. This information is, in turn, used to route the incoming call to an advisor 58 who also speaks the same language as the user. Once the call is routed to advisor 58, the digital portion of the call ends and voice communication between the user and advisor 58 commences. Accordingly, in the example described above, the call initiated by telematics unit 24 would be routed to an advisor 58′ who, as indicated in FIG. 3, speaks English.

In another example, rather than routing the call at call center 18 to human advisor 58, the switch at the call center routes the call to ACR 59, where a particular language interpreting component of ACR 59 is selected. ACR 59 responds to the incoming data portion of the call wherein the language information is conveyed to ACR 59 and activates a language interpreting component that is responsive to the current telematics language, English.

In some examples, telematics unit 24 may be further configured to digitally provide additional information to call center 18 indicative of the proposed telematics language which, in the example provided above, would be the new vehicle language (Spanish). This additional information may be used by call center 18 to route the incoming call to advisor 58″, who, as indicated in FIG. 3, speaks Spanish. In examples where ACR 59 is utilized to respond to such incoming calls, during the data portion of the call, the proposed telematics language would be communicated to ACR 59 and ACR 59 would activate a language interpreting component configured to interact with the caller in the new vehicle language (i.e., Spanish).

In some examples, electronic component 76 may support languages that are not supported by telematics unit 24. In the event that the user selects a new vehicle language that is not supported by telematics unit 24, the telematics unit may be configured to refrain from initiating a call to call center 18 because a change of the telematics language will not occur and there will be no need for advisor involvement.

Alternatively, telematics unit 24 may be configured to initiate the call to call center 18, but may not include a digital identification of the proposed telematics language. This would result in the call to call center 18 being routed to advisor 58′ who speaks the current telematics language (English) and who could address any language change issues arising out of the change in vehicle language with the user in the user's language of record. Alternatively, telematics unit 24 may digitally include an identification of the unsupported new vehicle language and may further include digital instructions to the effect that, despite the selection of a new vehicle language, the call be routed to an advisor 58 who speaks the current telematics language.

In another alternative, telematics unit 24 may digitally identify the unsupported new vehicle language and the call may be routed to an advisor 58 who speaks an associated telematics language. As used herein, an associated telematics language is a language that differs from the proposed telematics language but which the user is assumed to understand. For example, it is very common that persons who speak Swiss also speak French. Accordingly, if the user changed the vehicle language from English to Swiss, the call to call center 18 would be routed to advisor 58′″ who, as indicated in FIG. 3, speaks French.

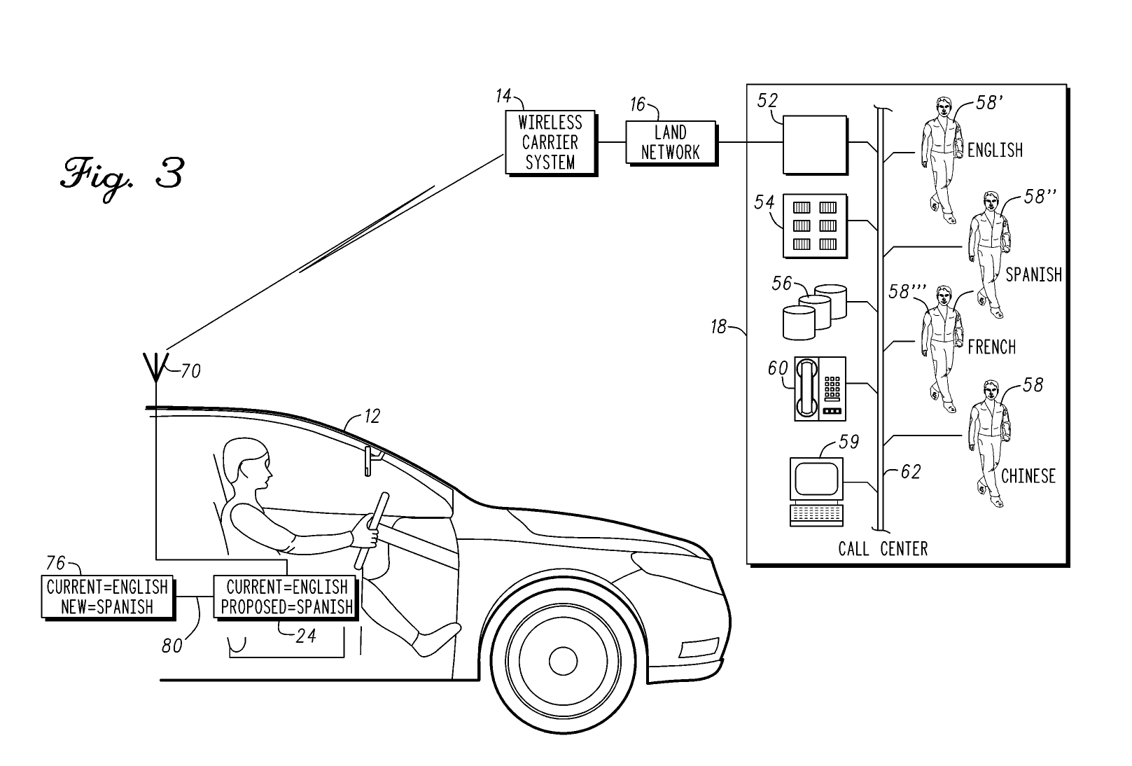

With respect to FIG. 4, an example of a method for synchronizing the telematics language with the vehicle language is illustrated. At step 84, telematics unit 24 receives information indicative of a user initiated change of the vehicle language from the current vehicle language to the new vehicle language. Such information may be obtained by monitoring vehicle bus 80, by directly monitoring electronic component 76, but monitoring other electronic components communicatively connected to vehicle bus 80, or by any other means effective to determine that the vehicle language has changed.

At step 86, telematics unit 24 automatically initiates a call to call center 18 once the change of the vehicle language has been detected. Telematics unit 24 may include information identifying the proposed telematics language, as discussed above, which will help to determine appropriate call routing.

At step 88, advisor 58 confirms the users' desire to change from the current telematics language to the proposed telematics language. At this time, advisor 58 can inform the user of the consequences of changing the telematics language. Upon receiving confirmation from the user that the user desires to change the telematics language, advisor 58 can send an electronic signal to telematics unit 24 effecting the change of the telematics language. The advisor may also update the user's profile to reflect the user's election of a new telematics language.

While at least one exemplary system and method have been presented in the foregoing detailed description, it should be appreciated that a vast number of variations exist. It should also be appreciated that the examples disclosed herein are not intended to limit the scope, applicability, or configuration in any way. Rather, the foregoing detailed description will provide those skilled in the art with a convenient road map for implementing the examples. It should be understood that various changes can be made in the function and arrangement of elements without departing from the scope as set forth in the appended claims and the legal equivalents thereof.

What is claimed is:

1. A system for synchronizing changes of a telematics language from a current telematics language to a proposed telematics language with changes made to a vehicle language from a current vehicle language to a new vehicle language through involvement of a call center, the system comprising:
an antenna adapted for attachment to a vehicle and configured for transmitting and receiving communication transmissions to and from the call center; and
a telematics unit adapted for attachment to the vehicle and communicatively connected to the antenna, the telematics unit being configured to:
monitor a vehicle bus to detect when a user changes the vehicle language from the current vehicle language to the new vehicle language, and
automatically initiate contact with the call center when the change in the vehicle language is detected to confirm a user desire to change the telematics language to the new vehicle language.

2. The system of claim 1, wherein the telematics unit is further configured to initiate contact with an advisor at the call center who speaks the current telematics language.

3. The system of claim 1, wherein the telematics unit is further configured to initiate contact with an advisor at the call center who speaks the new vehicle language.

4. The system of claim 3, wherein the telematics unit is further configured to initiate contact with an advisor at the call center who speaks the current telematics language if the telematics unit does not support the new vehicle language.

5. The system of claim 1, wherein the telematics unit is further configured to refrain from initiating contact with the call center when the new vehicle language is not supported by the telematics unit.

6. The system of claim 1, wherein the telematics unit is further configured to initiate contact with an advisor at the call center who speaks an associated vehicle language when the new vehicle language is not supported by the telematics unit.

7. The system of claim 1, wherein the telematics unit is configured to initiate contact with an automated call response system located at the call center.

8. A system for synchronizing changes of a telematics language from a current telematics language to a proposed telematics language with changes made to a vehicle language from a current vehicle language to a new vehicle language through involvement of a call center, the system comprising:
an electronic component configured to be mounted to a vehicle and configured to enable a user to change the vehicle language to the new vehicle language;
a telematics unit adapted for attachment to the vehicle and communicatively connected to the electronic component, the telematics unit being configured to:
detect a change in the vehicle language, and
automatically initiate contact with the call center when the change in the vehicle language is detected to confirm a user desire to change the telematics language to the new vehicle language.

9. The system of claim 8, wherein the telematics unit is further configured to initiate contact with an advisor at the call center who speaks the current telematics language.

10. The system of claim 8, wherein the telematics unit is further configured to initiate contact with an advisor at the call center who speaks the new vehicle language.

11. The system of claim 10, wherein the telematics unit is further configured to initiate contact with an advisor at the call center who speaks the current telematics language if the telematics unit does not support the new vehicle language.

12. The system of claim 8, wherein the telematics unit is further configured to refrain from initiating contact with the call center when the new vehicle language is not supported by the telematics unit.

13. The system of claim 8, wherein the telematics unit is further configured to initiate contact with an advisor at the call center who speaks an associated vehicle language when the new vehicle language is not supported by the telematics unit.

14. The system of claim 8, wherein the telematics unit is further configured to monitor a vehicle bus to determine when a user changes the vehicle language from the current vehicle language to the new vehicle language.

15. The system of claim 8 wherein the electronic component is a vehicle radio.

16. A method for synchronizing languages, the method comprising the steps of:
receiving, at a telematics unit, information indicative of a user initiated change of a vehicle language from a current vehicle language to a new vehicle language;
automatically initiating contact with a call center using the telematics unit;
confirming, by the call center, a user desire to change a telematics language from a current telematics language to the new vehicle language.

17. The method of claim 16 wherein the step of automatically initiating contact comprises directing an incoming call to the call center to a first available advisor.

18. The method of claim 16 wherein the step of automatically initiating contact comprises directing an incoming call to the call center to an advisor who speaks the current telematics language.

19. The method of claim 16 wherein the step of automatically initiating contact comprises directing an incoming call to the call center to an advisor who speaks the new vehicle language.

20. The method of claim 19 wherein the step of automatically initiating contact step further comprises directing the incoming call to an advisor who speaks the current telematics language if the new vehicle language is not supported by the telematics unit.
